(19) United States
(12) Patent Application Publication
(10) Pub. No.: US 2010/0259539 A1
(43) Pub. Date: Oct. 14, 2010

(54) Camera placement and virtual-scene construction for observability and activity recognition

(76) Inventors: Nikolaos Papanikolopoulos, Minneapolis, MN (US); Robert Bodor, Hoboken, NJ (US)

Correspondence Address: SCHWEGMAN, LUNDBERG & WOESSNER, P.A., P.O. BOX 2938, MINNEAPOLIS, MN, 55402, US

(21) Appl. No.: 11/491,516

(22) Filed: Jul. 21, 2006

Related U.S. Application Data
(60) Provisional application No. 60/701,465, filed on Jul. 21, 2005.

(51) Int. Cl. G06T 17/00; H04N 7/18; H04N 13/02

(52) U.S. Cl. 345/420; 348/159; 348/E07.085; 348/E13.074

(57) ABSTRACT

Multiple cameras are placed at a site to optimize observability of motion paths or other tasks relating to the site, according to a quality-of-view metric. Constraints such as obstacles may be accommodated. Image sequences from multiple cameras may be combined to produce a virtual sequence taken from a desired location relative to a motion path.

### CLAIM OF PRIORITY

This application claims priority under U.S. Provisional Application Ser. No. 60/701,465, filed Jul. 21, 2005.

### GOVERNMENT INTEREST

The government may have certain rights in this patent under National Science Foundation grant IIS-0219863.

### INCORPORATION BY REFERENCE

This document incorporates by reference “Multicamera Human Activity Recognition in Unconstrained Indoor and Outdoor Environments,” by Robert Bodor, submitted May 2005 to the Faculty of the Graduate School of the University of Minnesota in partial fulfillment of the requirements for the degree of Doctor of Philosophy. This thesis was also incorporated into the above-noted provisional application, and is publicly available.

### TECHNICAL FIELD

The subject matter relates to image capture and presentation, and more specifically concerns placing multiple cameras for enhancing observability for tasks such as motion trajectories or paths of a subject, and combining images from multiple cameras into a single image for recognizing features or activities within the images.

### BACKGROUND

Electronic surveillance of both indoor and outdoor areas is important for a number of reasons, such as physical security and customer tracking for marketing, store layout-planning purposes, the classification of certain activities such as recognition of suspicious behaviors, and robotics or other machine intelligence. In the applications considered herein, multiple cameras or other image sensors may be positioned throughout the designated area. In most cases, the cameras have electronic outputs representing the images, and the images are sequences of video frames sufficiently closely spaced to be considered real-time or near real-time video. For some applications, the images may be viewed directly by a human operator, either contemporaneously or at a later time. Some applications may require additional processing of the images, such as analysis of the paths taken by humans or other objects in the area, or recognition of activities of humans or other objects as belonging to one of a predefined set of classes or categories.

In the field of activity recognition in particular, recognition may depend heavily upon the angle from which the activity is viewed. In most conventional systems of this type, recognition is successful only if the path of the object's motion is constrained to a specific viewing angle, such as perpendicular to the line of motion. A solution to this problem might be to develop multiple sets of training patterns for each desired class for different viewing angles. However, we have found that successful recognition may fall off significantly for small departures from the optimum angle, requiring many sets of patterns. Further, some activities are difficult or impossible to recognize from certain viewing angles.

### DRAWING

FIG. 1 is an idealized representation of an example site for placing cameras and capturing images therefrom.

FIG. 2 is a high-level schematic diagram of a system for placing cameras at a site such as that of FIG. 1.

FIG. 3 is a high-level flowchart of a method for placing cameras.

FIG. 4 is a high-level schematic diagram of a system for producing virtual sequences of images from multiple cameras such as those of FIG. 1.

FIG. 5 is a high-level flowchart of a method for producing virtual image sequences.

### DESCRIPTION OF EMBODIMENTS

### Camera Placement for Observability

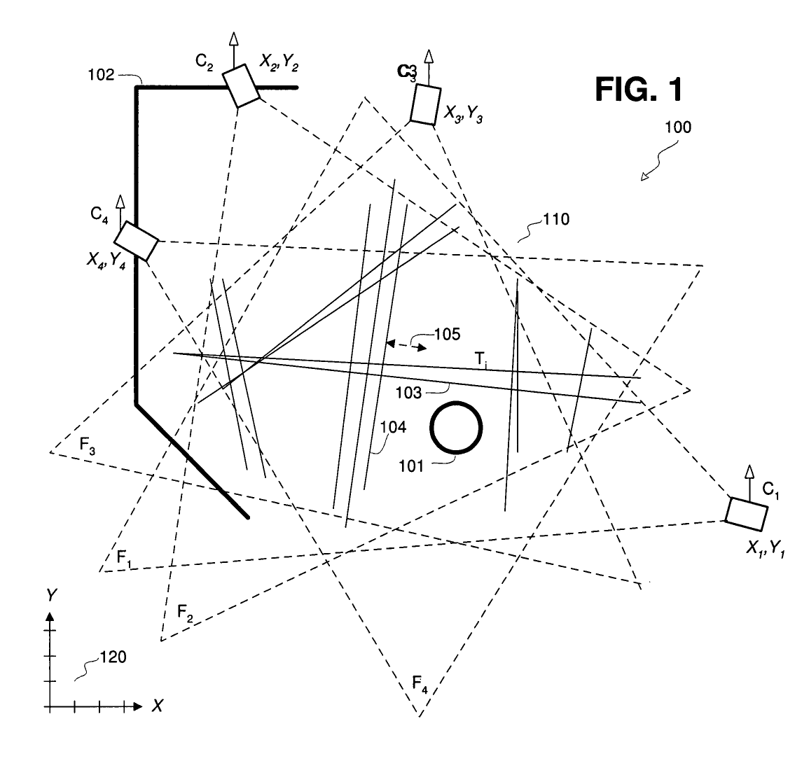

FIG. 1 shows an idealized example of a site 100, such as a store, a shopping mall, all or part of an airport terminal, or any other facility, either indoor or outdoor. A set of paths or trajectories Tᵢ derived from motions of people or other subjects of interest traversing site 100 define tasks to be observed. These trajectories may be obtained by prior observation of site 100. They are here assumed to be straight lines for simplicity, but could have other shapes and dimensionalities. Tasks other than motion trajectories may alternatively be defined, such as hand motions for sign-language or hand-signal recognition, or head positions for face recognition.

A group of cameras C at respective site coordinates X,Y observe area 110. The term “camera” includes any type of image sensor appropriate to the desired application, such as still and video cameras with internal media or using wired or wireless communication links to another location. The cameras need not be physically positioned within area 110, or even inside site 100. Their number may be specified before they are placed, or during a placement process, or iteratively. Each camera has a field of view F shown in dashed lines. This example assumes that all the cameras have the same prespecified field of view, but they may differ, or may be specified during the placement process. The field of view may be specified by a view angle and by a maximum range beyond which an object image is deemed too small to be useful for the intended purpose. The cameras may produce single images or sequences of images such as a video stream. The term “image” herein may include either type. A site-wide coordinate system or grid 110 may specify locations of cameras C in common terms. Grids, polar coordinates, etc. for individual cameras may alternatively be converted later into a common system, or other position locating means may serve as well. A third dimension, such as a height Z (not shown) above a site reference point may also specify camera locations.

Site 100 may include other features that may be considered during placement of cameras C. Visual obstructions such as 101 may obscure portions of the field of view of one or more of the cameras C horizontally or vertically. Further, the camera locations may be limited by physical or other constraints such as 102, only one of which is shown for clarity. For example, it may be practical to mount or connect cameras only along existing walls or other features of site 100. Constraints may be expressed as lines, areas, or other shapes in the coordinate system of site 100. Constraints may also be expressed in terms of vertical heights, limitations on viewing angles, or other characteristics. Constraints may be expressed negatively as well as positively, if desired. More advanced systems may handle variable constraints, such as occlusions caused by objects moving in the site, or cameras moving on tracks. Cameras may be entirely unconstrained, such as those mounted in unmanned aerial vehicles.

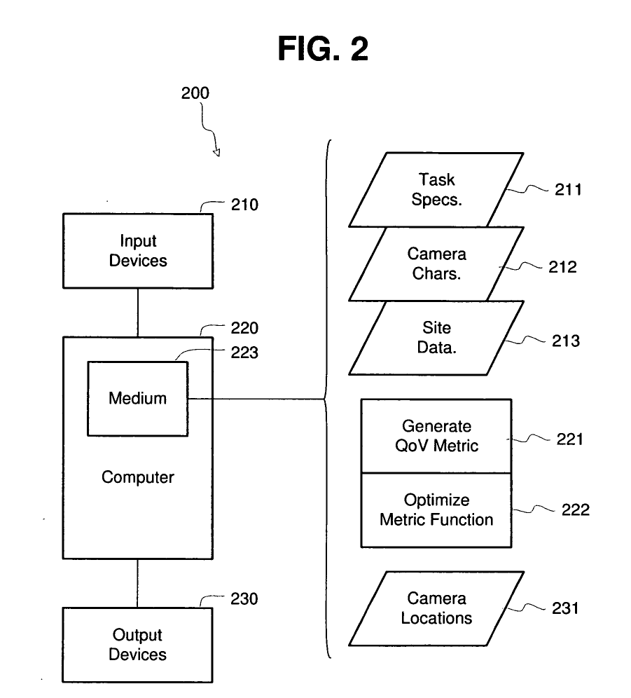

FIG. 2 is a high-level schematic diagram of a system 200 for positioning cameras C at a site 100 for enhanced visibility of a designated area 110, FIG. 1.

Input devices 210, such as one or more of a keyboard, mouse, graphic tablet, removable storage medium, or network connection, may receive input data. Such data may include specifications 211 regarding the tasks, such as coordinates trajectories Tᵢ in terms of a coordinate system such as 120, FIG. 1. Data 212 may include certain predefined characteristics of the cameras C, such as their number, view angle, or number of pixels (which may set their maximum usable range). Site data 213 relates to aspects of the site, such as its coordinate system 120. Site data 213 may include locations of obstacles 101, permissible camera locations 102, or other constraints or features that affect camera placement. In this example, a fixed number of cameras are assumed to have a fixed focal length and viewing direction. However, a more general system may receive and employ camera characteristics such as a range of numbers of cameras, or zoom, pan, or tilt parameters for individual cameras.

Computer 220 contains modules for determining desired locations of cameras C with respect to coordinate system 120 of site 100. A preliminary module, not shown, may analyze images of the site to segment out subjects to be tracked, and may then automatically calculate the trajectories Tᵢ, if desired. Module 221 generates a quality-of-view (QoV) cost function or metric for each of the tasks for each of the cameras. Module 222 optimizes the value of this metric over all of the tasks for all of the cameras, taking into consideration any placement constraints or obstructions. Optimization may be performed in closed form or iteratively. This optimum value produces a set of desired camera locations, including their pointing directions.

Output devices 230 receive output data 231 specifying the coordinates and directions of desired camera locations. Other data may also be produced. If the optimum metric value is not sufficiently high, different data 211, 212, or 213 may be input, and modules 221, 222 executed again. Data and instructions for modules 221, 222 may be stored in or communicated from a medium 223 such as a removable or nonremovable storage device or network connection.

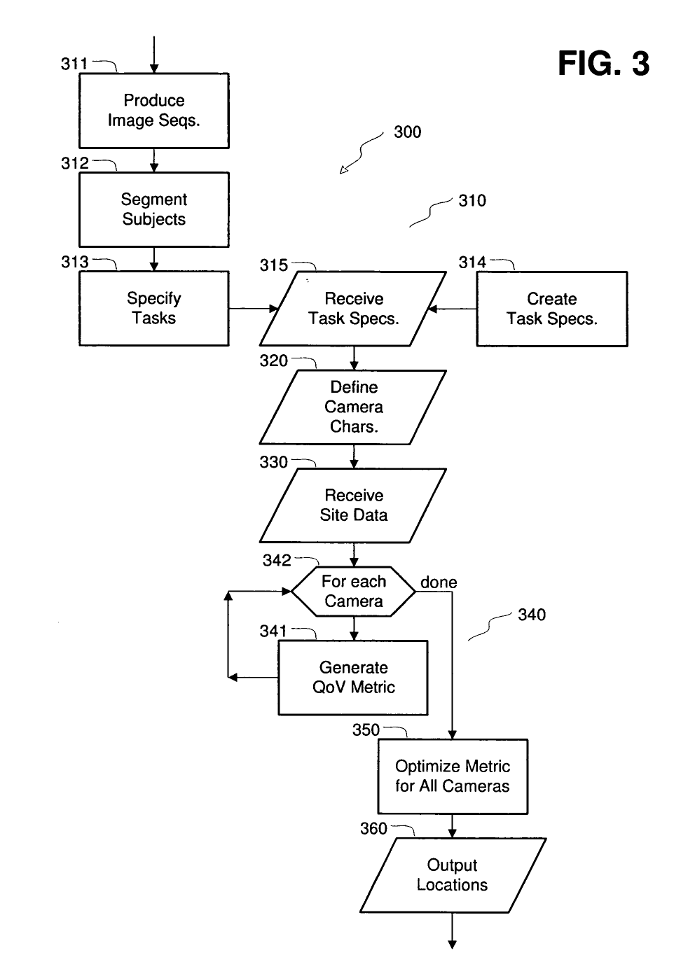

FIG. 3 outlines high-level activities 300 that may be performed by an apparatus such as 200, FIG. 2, or in other ways.

Activities 310 concern the tasks to be analyzed. Activity 311 optionally produces sequences of images of a desired area 110. The images may be produced from one or more cameras provisionally placed at site 100, or in any other suitable way. Activity 312 may segment the images so as to isolate images of desired subjects from the background of the images. In this example, segmentation 312 may isolate human subjects from other image data for better tracking of their motion. Many known segmentation methods may serve this purpose. Activity 313 may specify the tasks by, for example, producing representations of paths or trajectories traversed by human subjects within area 110. The trajectories may take the form of sequences of coordinates 120 along the trajectories, or the trajectories may be approximated by a few coordinates that specify lines or curves. As one of many alternatives, an operator may directly create specifications of trajectories (or other types of tasks) at an activity 314. Method 300 receives the task specifications, however generated, at 315.

Activity 320 defines a set of camera characteristics. Predetermined fixed characteristics for a given application may be received from an operator or other source. For example, the total number of cameras may be fixed, or the same field of view for all cameras may be specified. Alternatively, these or other defined parameters may be allowed to vary.

Activity 330 receives the site data or specifications 213, FIG. 2. This data 213 may include a grid or other system for defining site coordinates, constraints such as locations of obstacles 101 within the cameras' fields of view or permissible camera locations within or near area 110 of site 100, or other parameters relating to the site.

Activity 341 of blocks 340 generates a QoV metric or cost, gain, or objective function for each camera. As will be detailed below, the metric measures how well one of the cameras can see each of the defined tasks. For the example of trajectory tasks, the metric may encode the extent to which each trajectory lies within the field of view of the camera for various locations at which the camera may be placed. The metric may incorporate constraints such as permissible (or, equivalently, prohibited) camera locations, or constraints such as restrictions upon its field of view due to obstacles or other features. The field of view may be incorporated in various ways, such as angle of view or maximum distance from the camera (possibly specified as resolution or pixel numbers). Camera capabilities such as pan, zoom, or tilt may be incorporated into the metric function. Activity 342 repeats block 340 for each camera. The result is a metric that provides a single measure of how well all of the cameras include each of the tasks within their fields of view.

Activity 350 optimizes the value of the metric, to find an extreme value. This value may be a maximum or minimum, depending upon whether the QoV metric is defined as a figure of merit, a cost function, etc. The metric will assume its extreme value for those camera locations which maximize the overall coverage of the desired tasks, within any received restrictions on their locations, fields of view, characteristics, and so forth. As described below, optimization may be performed for all cameras concurrently, or for each camera in turn.

Activity 360 may output the camera locations corresponding to the extreme value determined in block 350. The locations may be printed, displayed, communicated to another facility, or merely stored for later use.

The quality of view of a task of course depends upon the nature of the tasks to be observed. For example, face recognition or gait analysis may emphasize a particular viewing angles for the subjects. The present example develops QoV metrics for observing motion paths of human or other subjects. That is, the tasks are trajectories representing motions across a site such as 100, FIG. 1.

Several simplifying assumptions reduce complex details for description purposes. Extensions to remove these assumptions, when desired, will appear to those skilled in the art. First, paths or trajectories need be viewed from only one side. Second, paths are assumed to be linear. This assumption may be effectively relaxed by fitting lines to tracking data representing the paths, and by breaking highly curved paths into segments. The camera representation uses a pinhole model, which ignores lens distortion and other effects. Third, the foreshortening model considers only first-order effects, ignoring higher orders.

Subject paths may form a set of points xᵢ(t) represented by a state vector X(t)=[x₁(t)^{T} . . . xₙ(t)^{T}]^{T}. The distribution of subject paths is defined over an ensemble of state-vector trajectories, Yᵢ={X(1) . . . X(t)}, where Yᵢ is the i^{th} trajectory in the ensemble. Y=f(s) may then denote a parametric description of the trajectories. Linear paths may be parameterized in terms of an orientation angle, two coordinates of the path center, and path length, although any number of parameters may be used.

The state of each camera may be parameterized in terms of an action uⱼ that carries the camera location from default values to current values, such as rotation and translation between camera-based coordinates and site coordinates. The parameters that comprise components of vector uᵢⱼ include location variables such as camera location, orientation, or tilt angle. These parameters may also include certain defined camera characteristics, such as focal length, field of view, or resolution. In a particular application, a given characteristic parameter may be held fixed, or it may vary. The number of cameras may be considered a parameter, in that it determines the total number of vectors.

The problem of finding a good camera location for a set of trajectories may be formulated as a decision-theory problem that attempts to maximize the value V of an expected-gain function G (alternatively, minimize a cost function), where the expectation is performed across all trajectories. This may be expressed as:

$$V ( {u}_{1} , … , {u}_{n} ) = {\int }_{s ∈ S} G ( s , {u}_{1} , … , {u}_{n} ) p ( s ) d s ,$$

where G has variables representing trajectory states s and camera characteristic parameters u. The function p(s) represents a prior distribution on the trajectory states; this may be calculated from data 211, generated as in activities 310, FIG. 3, or even estimated as a probability distribution. Given a set of sample trajectories, the gain function may be approximated by:

$$V ( {u}_{1} , … , {u}_{n} ) = {\sum }_{j}^{samples} G ( s , {u}_{1} , … , {u}_{n} ) .$$

For a single camera, observing an entire trajectory requires the camera to be far enough away that the path is captured within the field of view. In FIG. 1, path 103 barely lies within the field of view F₃ of camera C₃. In three dimensions, this corresponds to the requirement that the path lie within a view frustum of the camera as projected upon a ground or base plane of area 110. This imposes four linear constraints per camera that must be satisfied for a path to contribute to the metric for a camera in a particular location.

Maximizing the view of the subject on a trajectory requires the camera to be close to the subject, so that the subject is as large as possible. For a fixed field of view, the apparent size of the subject decreases with increasing distance d to the camera. For digital imaging, the area of a subject in an image corresponds to a number of pixels, so that observability may be defined directly in terms of pixel resolution, if desired. A first-order approximation may calculate resolution as proportional to 1/d².

Foreshortening reduces observability as the angle decreases between a camera's view direction and a trajectory. For example, trajectory 104 is much less observable to camera F₃ than is trajectory 103, in FIG. 1. For this effect, a first-order approximation may calculate resolution as proportional to the cosine of the angle. Foreshortening may have two sources: horizontal/vertical-plane angles θ,α between the camera and a normal to the path center, and horizontal/vertical angles φ,β between the path center and the image plane of the camera.

Also, to ensure that the full motion sequence is in view, a camera should maintain a minimum distance from each path, d₀=(rₐlⱼf)/w, where rₐ is the image aspect ratio, lⱼ is the path length, f is the lens focal length, and w is the diagonal width of the image sensor.

For this geometry, a metric for each path/camera pair i,j may be defined as:

$${G}_{ij} = \frac{{d}_{0}^{2}}{{d}_{ij}^{2}} cos ( {θ}_{ij} ) cos ( {ϕ}_{ij} ) cos ( {α}_{ij} ) cos ( {β}_{ij} )$$

Optimizing this function over the camera parameters yields locations for a single path j with respect to a single camera I.

Multiple paths may then be handled by optimizing over an aggregate observability function of the entire set of paths or trajectories:

$$V = {\sum }_{j}^{paths} {G}_{j} .$$

This formulation gives equal weights to all paths, so that a single camera optimizes the average path observability. However, different paths may be weighted differently, if desired. V has no units; however, multiplying it by the image size in pixels yields a resolution metric of observability.

The next step, optimizing observability of multiple paths jointly over multiple cameras, may employ a joint search over all camera parameters u at the same time. Although this would ensure a single joint optimum metric V, such a straightforward search would be computationally intensive—in fact, proportional to (km)ⁿ, where k is the number of camera parameters, m is the number of paths, and n is the number of cameras.

For many applications, a less complex iterative search, proportional to kmn, may be preferable. For example, an airport or train station may have 50-100 cameras. An iterative approach may also allow adding cameras without re-optimizing from the beginning. Moreover, an iterative method may produce solutions that closely approximate a global optimum where local maxima of the objective function are sufficiently separated from each other. Separated maxima correspond to path clusters within the overall set of paths that are grouped by position or orientation. Such clusters tend to occur naturally in typical environments, because of features of the site, such as sidewalks, doorways, obstacles, and so forth. For clusters separated in position or orientation, a camera-placement solution that observes one cluster well may have a significantly lower observability of another cluster, so that they may be optimized somewhat independently of each other. Because iterative approaches may not reach the theoretical extreme value of the QoV metric, the terms “optimize” and optimum” herein also include values that tend toward or approximate a global extreme, although they may not quite reach it.

The following describes an iterative method for placing multiple cameras that has performed well in practice for observing trajectories of subjects at typical sites.

A vector of path observabilities per camera Gᵢ has elements Gᵢⱼ describing the observability of path j by camera I. Constant vectors G₀=[0, . . . , 0] and I=[1, . . . , 1] simplify notation. For each camera, the objective function becomes:

$${V}_{i} = {\sum }_{j}^{paths} [ {\prod }_{k = 1}^{i} ( I - {G}_{k - 1 , j} ( {u}_{k - 1} ) ) ] {G}_{ij} ( {u}_{i} ) .$$

Inverting the observability values of the previous camera, I-Gₖ₋₁, directs the current camera k to regions of the path distribution that have the lowest observability so far. That is, a further camera is directed toward path clusters that the previous camera did view well, and so on.

Then the overall observability or QoV metric over all cameras becomes:

$$V = {\sum }_{i}^{cameras} [ {\sum }_{j}^{paths} [ {\prod }_{k = 1}^{i} ( I - {G}_{k - 1 , j} ( {u}_{k - 1} ) ) ] {G}_{ij} ( {u}_{i} ) ]$$

Maximizing V optimizes the expected value of the observability, and thus optimizes the QoV metric for the entire set of paths or trajectories. Again, if the path clusters are not well separated, the result may be somewhat less than the global maximum. Also, the aggregate maximum may sacrifice some amount of observability of individual paths.

Observability may asymptotically approach a maximum as the number of cameras increases. A sufficient number of cameras for a given QoV is not known a priori. However, it may be possible in many cases to use this approach to determine a number of cameras to completely observe any path distribution to within a given residual. Experimental results have shown that the iterative method may consistently capture all of the path observability with relatively few cameras. Even where clusters are not independent, experiments have shown that the iterative solution requires only one or two more cameras than does the much more expensive theoretically optimum method.

While the QoV definition above is recursive, the value of the QoV metric is symmetric in all terms—all sets of camera parameters. In fact, following the known inclusion-exclusion principle, the above equation defines the per-path union of gains from all cameras, allowing it to be rewritten in the form:

$$V = {⋃}_{i}^{cameras} [ {\sum }_{j}^{paths} {G}_{ij} ]$$

This indicates that the order in which camera placement is optimized does not affect the outcome of the optimization. The order in which camera parameters are considered may be changed without affecting the equation. Moreover, this formulation ensures that the maximum gain or metric of any path is unity, regardless of the number of cameras. As a result, if any of the cameras has an optimal view, Vⱼ=1, then the term for that path does not influence the placement of any other cameras, and the term for that path may be removed.

The QoV objective function may consider a number of camera parameters in a number of forms. These parameters may include camera-location variables, for example X,Y, and Z coordinates and pitch, roll, and yaw of the camera. In most cases, roll angle is not significant; it merely rotates the image and has no effect upon observability. In many environments, height Z above a base plane is constrained, and may be held constant. This may occur when camera locations are constrained to ceilings or building roofs. Pitch angle then becomes coupled to the constrained height, and may also be eliminated as a free parameter. Parameters may also include intrinsic camera parameters, such as focal length, resolution (pixel number). In some applications, all of the cameras may have the same characteristics, so that these also may be eliminated as free parameters. If such simplifying assumptions are justified, then the objective functions may reduce to the simple form:

$${G}_{ij} = \frac{{d}_{0}^{2}}{{d}_{ij}^{2}} cos ( {θ}_{ij} ) cos ( {ϕ}_{ij} )$$

noted above. The action vector u may simplify to a vector in three variables: X and Y locations and a yaw or pointing angle γ. These three variables may be easily converted from values relative to the cameras so as to position and orient in the global coordinate system 120 of the site.

The three (or more) parameters may be optimized by iterative refinement based upon, for example, well-known constrained nonlinear optimization processes. The constrained QoV objective function may be evaluated at uniformly spaced intervals of the parameters of action vector u. In regions where the slope |∂V/∂u| becomes large, the interval between parameter values may be refined and further iterated. This method allows reasonable certainty of avoiding local minima, because it maintains a global reference picture of the objective surface, while providing accurate estimates in the refined regions. In addition, it may be faster than conventional methods such as Newton-Rapheson in the presence of complex sets of constraints.

As noted above, real-world environments often constrain the locations of cameras for one reason or another. For example, indoor sites may require cameras to be placed on a ceiling in order to achieve unoccluded views. Outdoor sites may restrict camera locations to rooftops, light poles, or similar objects. The formulation of the objective function may be extended to include placement constraint regions. The optimization process may then be easily restricted to or kept away from user-defined constraint regions. This may actually speed up the analysis. It may also allow the constraint optimum metric to be compared with a corresponding unconstrained optimum value, so as to gauge the effect of the constraints, for possible modification or other purposes.

Occlusions such as obstacles 102, FIG. 1, may also be incorporated into the objective function. One example method for achieving this goal removes occluded paths from the metric value calculation for a given set of camera parameters. If an obstacle comes between a camera and a path, then that path cannot be observed by the camera, and therefore is prohibited from contributing to the observability value for that camera. As noted earlier, the locations and dimensions of such obstacles may be input by any convenient means, such as data 213, FIG. 2.

The objective functions described above are formulated to enhance observability. Other formulations may emphasize different goals. For example, the cosine terms of the Gᵤ function above may be raised to a power ω. Setting ω=0 may be appropriate for 3D image reconstruction applications, where cameras should be spread evenly around the subjects, and not favor any single view or path. Setting ω>1 it is important to favor a particular viewpoint for articulated motion recognition based upon image sequences taken from a single viewpoint, as described in the next section; higher powers would drive camera placement toward perpendiculars of the motion paths.

### Virtual-Scene Construction

Observing subjects or their trajectories may be an end in itself. Other applications, however, may wish to pursue further goals, for example, recognizing faces of the subjects, or classifying activities such gaits of the subjects. A number of such goals may be facilitated by observing the subjects from a particular direction relative to the subject's path of motion. For instance, recognizing whether human subjects are walking or running is easier when the subjects can be observed from directions approximately perpendicular to the direction in which they are moving. If the subject's orientation or motion direction is unconstrained or unknown a priori, a single camera cannot in general be placed so as to observe all subjects from the preferred direction. For large sites or those with complex geometry, even a reasonable number of multiple cameras may not provide a preferred viewing direction from any single one of the cameras.

This difficulty may be overcome by observing subject trajectories or paths from cameras facing in multiple different directions, and then combining image sequences from at least two of the cameras so as to form a virtual scene from the direction of a virtual camera having a location different from any of the real cameras.

For virtual-scene construction, multiple cameras C at site 100, FIG. 1, may be placed to observe area 110 from multiple directions. Placement may be performed by methods described above, by other automatic or manual methods. Camera locations—this term again includes pointing directions—allow subjects to be viewed from at least two directions that differ significantly from each other. The subjects or their trajectories may be oriented in different directions. They may be specified as a set in advance, determined by prior observation of site 100, or given from any other source. Trajectories need not be identified as discrete paths such as those shown in FIG. 1; instead, an area 110 may be defined by boundaries or other means, and the desired trajectories may comprise all paths within the specified area. The trajectories may represent motion paths of subjects such as people, automobiles, etc., without restriction. Cameras C may be implemented as any desired form of image sensors, and may produce sequences of images such as video images.

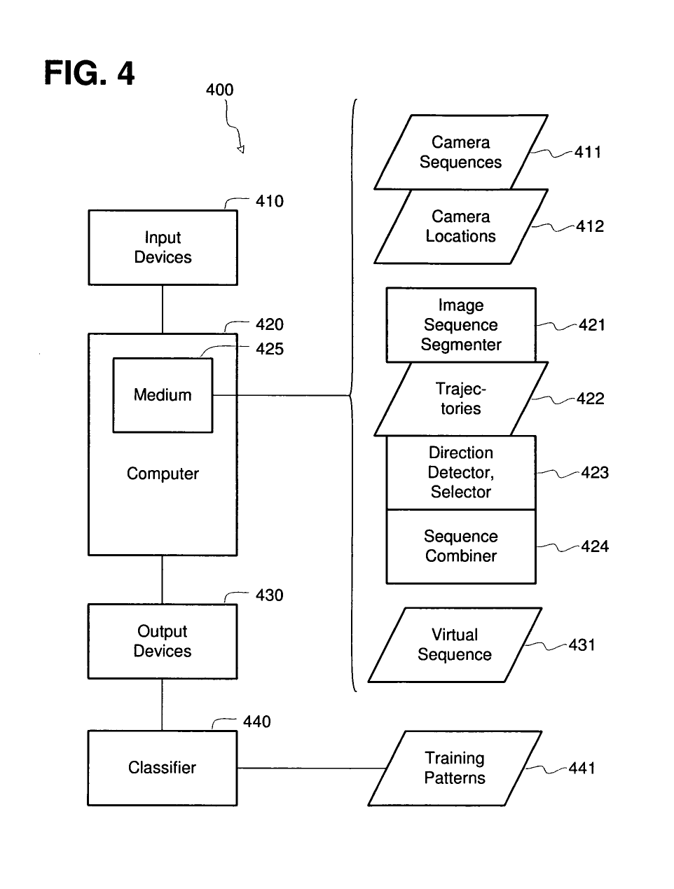

FIG. 4 is a high-level block diagram of a system 400 for constructing virtual scenes at a site 100, FIG. 1.

Input devices 410, such as one or more of a keyboard, mouse, graphic tablet, removable storage medium, or network connection, may receive input data. Such data includes images 411 from multiple cameras C in FIG. 1; again, the term “image” may refer to a single image or to a sequence of input images. Data 412 may include the locations of cameras C, perhaps with respect to an overall site coordinate system 120.

Computer 420 contains modules for constructing a virtual sequence from the real image sequences 411. A hardware or software module 421 may analyze the images from the site to segment out subjects to be tracked, and may then automatically calculate the trajectories Tᵢ, if desired. For example, module 221 may separate individual moving subjects from static backgrounds; such modules are known in the art. Although segmenters are capable of tracking multiple subjects concurrently, the following description posits a single trajectory for simplicity. The output of the segmenter is an observed trajectory 422, such as 104 in FIG. 1. Module 423 detects the direction of trajectory 104. It also selects two (or possibly more) of the real sequences 411 in response to the trajectory direction. Module 424 combines the selected image sequences to form a single virtual sequence that observes the trajectory from the desired angle.

Output devices 430 receive output data 431 containing images of the virtual sequence. Data and instructions for modules 411-431 may be stored in or communicated from a medium 425 such as a removable or nonremovable storage device or network connection.

A classifier or recognition module 440 may, if desired, recognize the virtual images as belonging to one of a number of categories. Classifier 440 may employ training patterns of images taken from the desired direction as exemplars of the categories. The classifier may be software, hardware, or any combination.

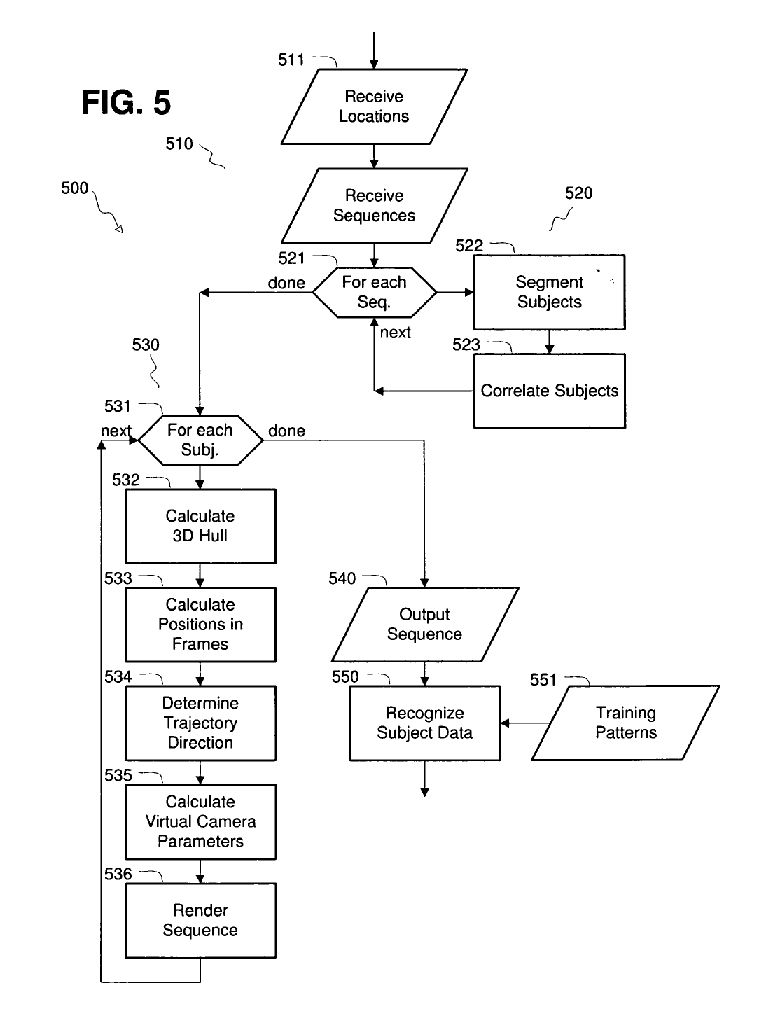

FIG. 5 outlines high-level methods 500 that may be performed by an apparatus such as 400, FIG. 4, or in other ways.

Activities 510 receive data concerning the locations of cameras C, FIG. 1. Camera location parameters may include X,Y positions of the cameras, the directions in which they point, and may further include ancillary data such as focal length, pitch angles, etc. Camera data may be received only once, only when a change occurs, or as otherwise desired. All other activities of method 500 may be performed continuously or concurrently with each other. For example, activity 512 would in most cases receive image sequences from cameras C concurrently with each other and during the processing of other activities. Image sequences may alternatively be stored for subsequent analysis if desired.

Activities in blocks 520 segment subjects from the image sequences. For each sequence, 521, block 522 may segment one or more subjects in the sequence images from the remainder or background of the images. Segmentation depends upon the nature of the subjects desired to be isolated from the background. This example concerns segmenting images of moving human subjects; other types of subjects may be segmented similarly. Multiple subjects may be appear in the images of a single sequence concurrently or serially, and may be identified by index tags or other means. The same subject may—in fact, normally will—appear in multiple sequences. For example, trajectory 104 of Fig. appears in image sequences from cameras C₂ and C₃, and partially in C₄ and C₁ (because of visual obstacle 101). Block 523 correlates each subject with the sequence(s) in which it appears, so that it can be identified as the same subject., among multiple possible subjects. Literature in the field describes methods for performing this function. If all the camera positions are accurately calibrated to a common reference frame, such as site coordinates 120, measurements taken within the images may suffice to identify a subject as the same in images from different cameras. The segmented images of each subject in each sequence are thus 2D silhouettes or profiles of that subject in each sequence. This may be accomplished by one or more of a relatively simple background subtraction, chromaticity analysis, or morphological operations. For outdoor environments, an adaptive intrinsic image method proposed by R. Martin, et al., “Using intrinsic images for shadow handling,” Proceedings of the IEEE International Conference on Intelligent Transportation Systems (Singapore 2002), may be employed. Other segmentation methods are known to the art, and may be implemented in hardware or software. Again, blocks 520 may process different sequences in parallel.

Activities 530 process each subject separately, 531, although normally in parallel with each other.

For each subject, activity 532 combines the 2D silhouettes or profiles to create a 3D hull of the subject, from the images in which that subject appears. Each silhouette carves out a section of a 3D space. The intersection of the carved-out sections then generates a 3D model or hull of the subject in a particular frame of the image sequences—that is, at a particular time. Silhouette-based 3D visual hull reconstruction has been extensively developed for computer-graphics applications such as motion-picture special effects, video games, and product marketing. The quality of the 3D reconstruction may be improved with more cameras, although some applications may require only a rough approximation of the 3D shape.

Activity 533 calculates the position of the current subject in multiple frames of the sequences. This may be achieved in a number of ways. In this example, block 533 uses the silhouette perimeters to extract a centroid location for each sequence. The position of each silhouette is then calculated as the bottom center of that silhouette—that is, the point where a vertical line through the centroid intersects the bottom of the silhouette in the perspective of each camera. This example assumes world coordinates relative to camera C₁, in order to accommodate assumptions in block 536 below, and constructs a geometry from the known locations of the other cameras. Converting the bottom center points to the common world reference, each point may be multiplied by the inverse of its camera's homography matrix, and then by the transformation matrix between its camera and C₁. The transformation matrix encodes translation and orientation (pointing direction) differences between a camera and the reference camera C₁. This product is then multiplied by the homography matrix of C₁ in order to fix the center point to the reference or ground plane for C₁. The subject's position for the frame is then calculated as the Euclidean mean of projections of the points into the world coordinates. Other methods may also serve.

Activity 534 determines the direction of motion of the trajectory. It reconstructs the trajectory of the subject by projecting the individual frame center points onto a reference plane in the world or site coordinates. This example approximates trajectories as straight lines and determines their directions and midpoints in the common site coordinates. Here again, other methods may be employed; for example, curved paths may be divided into multiple linear segments.

Block 535 calculates the parameters or characteristics of a virtual camera that would be able to view the subject from the desired direction. For the gait-recognition application, the desired orientation or pointing direction is perpendicular to the direction of the subject's trajectory. The virtual camera may be located along a perpendicular to the trajectory's midpoint, at a distance sufficient to view the entire trajectory sequence without significant wide-angle distortion, with its image axis pointed toward the trajectory. Other parameters of the virtual camera, such as pitch angle, may also be specified or calculated, if desired.

Activity 536 renders a virtual sequence of images from the parameters of the virtual camera as calculated in 535. Rendering may, for example, employ an approach similar to the technique introduced by S. Seitz, et al. in “View morphing,” Proceedings of ACM SIGGRAPH, 1996, pages 21-30. View morphing produces smooth transitions between images with interpolations of shape produced only by 2D transformations. The images selected for morphing are those of the two nearest real cameras—nearest in the sense of being physically located most closely to the desired location of the virtual camera. Other selection criteria may also serve, and more than two real cameras may be chosen, if desired. This and similar approaches do not restrict the virtual camera orientation axis to lie on a line connecting the orientation axes of the selected real cameras.

View morphing requires depth information in the form of pixel correspondences. These may be calculated using an efficient epipolar line-clipping method described in W. Matusik. et al., “Image-based visual hulls,” Proceedings of ACM SIGGRAPH, July 2000. This technique, which is also image-based, uses silhouettes of an object to calculate a depth map of the object's visual hull, from which pixel correspondences may be found.

Activity 540 outputs the final sequence, either the real sequence from block 524 or the virtual one from 536. Outputting may include storing, communicating, or any other desired output process.

Activity 550 may further process the output sequence. In this example, block 550 may perform gait recognition. Other applications may provide face recognition or classification, or any other form of processing. Again, although FIG. 5 shows blocks 540-550 occurring after other activities have finished, they may be performed at any time, including concurrently with other activities.

Recognition of gaits or other aspects of the tracked subjects may employ training sets 551 containing samples or archetypes of the classes into which the aspect is to be categorized. However, it is frequently infeasible to provide training patterns from every angle from which a subject may be viewed; in fact, some viewing angles may be unacceptable in any event, because they cannot reveal sufficient features of the activity. Therefore, the training patterns of present recognition systems tend to use views from a single favored direction. The classification accuracy of such systems often falls off rapidly as the viewing angle of the subject departs from the viewing angle of the training patterns. In fact, this is true for both machine and human perception. However, the present system, by constructing a virtual view that matches the angle of the training sequences, may significantly improve their performance. In fact, the present system may function to generate training sets in the favored direction from subjects whose motions are not constrained. As an example application, the document incorporated by reference herein describes a recognition system for classifying human gaits into eight classes: walk, run, march, skip, hop, walk sideways, skip sideways, and walk a line, using training views taken perpendicular to the subject's motion path. Experimental results showed that recognition levels dropped significantly for views that were only ten degrees away from the direction of the training set.

### CONCLUSION

The foregoing description and drawing illustrate certain aspects and embodiments sufficiently to enable those skilled in the art to practice the invention. Other embodiments may incorporate structural, process, and other changes. Examples merely typify possible variations, and are not limiting. Portions and features of some embodiments may be included in, substituted for, or added to those of others Individual components, structures, and functions are optional unless explicitly required, and activity sequences may vary. The word “or” herein implies one or more of the listed items, in any combination, wherever possible. The required Abstract is provided only as a search tool, and is not to be used to interpret the claims. The scope of the invention encompasses the full ambit of the following claims and all available equivalents.

1. A method for determining placement locations of multiple cameras at a site, comprising:
receiving data specifying tasks to be performed using images from the cameras;
defining characteristics for each of the cameras;
generating a quality-of-view (QoV) metric for each of the cameras with respect to the tasks and the characteristics, the metric being expressed in terms of possible locations for the each camera;
optimizing a value of the metric for all of the cameras over the tasks so as to produce a set of desired camera locations.

2. The method of claim 1 further comprising receiving site data, and where the QoV metric is further generated with respect to the site data.

3. The method of claim 2 where the site data concerns visual obstacles at the site.

4. The method of claim 2 where the site data concerns constraints upon locations of the cameras at the site.

5. The method of claim 1 further comprising observing images including a set of subjects at the site.

6. The method of claim 5 further comprising segmenting images of desired subjects from the images.

7. The method of claim 5 where the data specifying tasks include positions of a set of motion paths of the subjects at the site.

8. The method of claim 1 where the locations of the cameras include positions in a defined coordinate system and pointing directions.

9. The method of claim 8 where the coordinate system is a global coordinate system for all cameras at the site.

10. The method of claim 1 where the characteristics include a set of parameters for the cameras.

11. The method of claim 10 where the parameters further include any one or more of number of cameras, view angle, focal length, resolution, zoom, pan, or tilt.

12. The method of claim 10 where one or more of the parameters is held fixed.

13. The method of claim 1 where the metric is an objective function having an extreme value of the metric.

14. The method of claim 13 where the metric is expressed in terms of the locations of the cameras.

15. The method of claim 13 where the objective function is a sum over the cameras of a sum over the tasks of a function Gᵢⱼ of the camera locations and characteristics uᵢ.

16. The method of claim 15 where the objective function has substantially the form:
$$V = {\sum }_{i}^{cameras} [ {\sum }_{j}^{paths} [ {\prod }_{k = 1}^{i} ( I - {G}_{k - 1 , j} ( {u}_{k - 1} ) ) ] {G}_{ij} ( {u}_{i} ) ] ,$$
I being a unity vector.

17. The method of claim 13 where the objective function has substantially the form:
$$V = {⋃}_{i}^{cameras} [ {\sum }_{j}^{paths} {G}_{ij} ] .$$

18. The method of claim 13 where Gᵢⱼ has substantially the form:
$${G}_{ij} = \frac{{d}_{0}^{2}}{{d}_{ij}^{2}} cos ( {θ}_{ij} ) cos ( {ϕ}_{ij} ) ,$$
where d₀ represents a minimum distance from each path, dᵢⱼ represents a distance from camera I to a trajectory j, θᵢⱼ and φᵢⱼ represent angles between camera I and a normal to trajectory j.

19. The method of claim 13 where the metric is further expressed in terms of at least one of the characteristics.

20. The method of claim 1 where optimizing the metric comprises determining an extreme value for the objective function.

21. The method of claim 20 where the extreme value need not necessarily be a global extreme value.

22. The method of claim 20 where optimizing is performed iteratively.

23. The method of claim 20 where the objective function is optimized separately for at least some of individual ones of the cameras.

24. A machine-readable medium containing instructions, which when accessed, perform a method comprising:
receiving data specifying tasks to be performed using images from the cameras;
defining characteristics for each of the cameras;
generating a quality-of-view (QoV) metric for each of the cameras with respect to the tasks and the characteristics, the metric being expressed in terms of possible locations for the each camera;
optimizing a value of the metric for all of the cameras over the tasks so as to produce a set of desired camera locations.

25. The medium of claim 24 where the method further comprises receiving site data, and where the QoV metric is further generated with respect to the site data.

26. The medium of claim 24 where optimizing is performed iteratively.

27. Apparatus for determining placement locations of multiple cameras at a site, comprising:
at least one input device for receiving data specifying tasks to be performed using images from the cameras;
a computer for generating a QoV metric encoding a quality-of-view parameter for each of the cameras with respect to the tasks and characteristic parameters of the cameras, the metric being expressed in terms of possible locations for the each camera, and for producing an optimum value of the metric for all of the cameras over the tasks;
an output device for outputting a set of desired camera locations corresponding to the optimum value of the metric.

28. The apparatus of claim 27 where one of the input devices further receives site data, and where the QoV metric is further generated with respect to the site data.

29. The apparatus of claim 28 where the site data concerns visual obstacles at the site.

30. The apparatus of claim 28 where the site data concerns constraints upon locations of the cameras at the site.

31. The apparatus of claim 27 where the data specifying the tasks comprises specifications concerning a set of observed subjects at the site.

32. The apparatus of claim 31 where the specifications include positions of a set of motion paths of the subjects at the site.

33. The apparatus of claim 27 further comprising a plurality of cameras placed at the desired camera locations and coupled to at least one of the input devices for receiving sequences of images therefrom.

34. The apparatus of claim 27 where the optimum value is not necessarily a global extreme value of the metric.

35. The apparatus of claim 27 where the computer produces the optimum value iteratively.

36. A method for constructing a virtual scene, comprising
receiving multiple input images from a plurality of cameras at known locations at a site, and having fields of view in different directions;
generating multiple silhouettes of a subject in different ones of the input images;
combining the silhouettes so as to form a 3D hull of the subject;
selecting at least two of the silhouettes based upon a predetermined desired direction from the subject;
rendering a virtual image of the subject taken from the desired direction with respect to a virtual camera location that differs from any of the known locations of the cameras at the site.

37. The method of claim 36 further comprising calibrating the cameras so as to establish the known locations with respect to the site.

38. The method of claim 36 further comprising calculating parameters of the virtual camera.

39. The method of claim 36 further comprising segmenting the input images so as to separate the subject from other portions of the input images.

40. The method of claim 36 further comprising recognizing a feature of the subject from the virtual image.

41. The method of claim 40 where the feature is a gait of the subject.

42. The method of claim 40 where the feature is a face of the subject.

43. The method of claim 40 where recognizing includes receiving a set of training patterns of different subjects taken from the desired direction.

44. The method of claim 36 where
the input images comprise sequences of input images taken at different times,
the silhouettes comprise sequences of silhouettes,
the 3D hull includes a sequence of 3D hulls,
the virtual image comprises a sequence of virtual images.

45. The method of claim 44 where the desired direction is related to a direction of motion of the subject in the input images.

46. The method of claim 45 further comprising determining the direction of motion from the sequence of 3D hulls and from the known locations of the camera.

47. The method of claim 45 where determining the direction of motion includes calculating a centroid.

48. The method of claim 36 further comprising determining the known camera locations by:
receiving data specifying tasks to be performed using images from the cameras;
defining characteristics for each of the cameras;
generating a quality-of-view (QoV) metric for each of the cameras with respect to the tasks and the characteristics, the metric being expressed in terms of possible locations for the each camera;
optimizing a value of the metric for all of the cameras over the tasks so as to produce a set of desired camera locations.

49. A machine-readable medium containing instructions, which when accessed, performs a method comprising:
receiving multiple input images from a plurality of cameras at known locations at a site, and having fields of view in different directions;
generating multiple silhouettes of a subject in different ones of the input images;
combining the silhouettes so as to form a 3D hull of the subject;
selecting at least two of the silhouettes based upon a predetermined desired direction from the subject;
rendering a virtual image of the subject taken from the desired direction with respect to a virtual camera location that differs from any of the known locations of the cameras at the site.

50. The medium of claim 49 where
the input images comprise sequences of input images taken at different times,
the silhouettes comprise sequences of silhouettes,
the 3D hull includes a sequence of 3D hulls,
the virtual image comprises a sequence of virtual images,
the desired direction is related to a direction of motion of the subject in the input images.

51. The medium of claim 49 where the method further comprises recognizing a feature of the subject from the virtual image.

52. Apparatus for constructing a virtual scene, comprising:
an input device for receiving multiple input images from a plurality of cameras at known locations of a site, and having fields of view of a subject at the site from different directions;
a module for generating multiple silhouettes of a subject in different ones of the input images;
a module for combining the silhouettes so as to form a 3D hull of the subject;
a module for selecting at least two of the silhouettes based upon a predetermined desired direction from the subject;
a renderer for producing a virtual image of the subject taken from the desired direction with respect to a virtual camera location that differs from any of the known locations of the cameras at the site;
an output device for outputting the virtual image.

53. The apparatus of claim 52 further including a module for segmenting the input images so as to separate the subject from other portions of the input images.

54. The apparatus of claim 52 where
the input images comprise sequences of input images taken at different times,
the silhouettes comprise sequences of silhouettes,
the 3D hull includes a sequence of 3D hulls,
the virtual image comprises a sequence of virtual images,
the desired direction is related to a direction of motion of the subject in the input images.

55. The apparatus of claim 52 further comprising a classifier for recognizing a feature of the subject from the virtual image.

56. The apparatus of claim 55 further comprising a set of training patterns of different subjects taken from the desired direction.

57. The apparatus of claim 52 further comprising the plurality of cameras at the known locations.
